(19) United States
(12) Patent Application Publication
(10) Pub. No.: US 2021/0398424 A1
(43) Pub. Date: Dec. 23, 2021

(54) PARKING GUIDE SYSTEM AND METHOD FOR CONTROLLING THE SAME

(71) Applicants: Hyundai Motor Company, Seoul (KR); Kia Motors Corporation, Seoul (KR)

(72) Inventors: Sang Heon LEE, Seoul (KR); Jin Ho HWANG, Cheonan-Si (KR); Dong Eun CHA, Hwaseong-Si (KR); Jung An HYUNG, Gwangmyeong-Si (KR)

(73) Assignees: Hyundai Motor Company, Seoul (KR); Kia Motors Corporation, Seoul (KR)

(21) Appl. No.: 17/081,620

(22) Filed: Oct. 27, 2020

(30) Foreign Application Priority Data
Jun. 17, 2020 (KR) 10-2020-0073827

(51) Int. Cl. G08G 1/14; G08G 1/017; H04W 4/024; H04W 4/44; G06K 9/00

(52) U.S. Cl. CPC G08G 1/141; G08G 1/146; G08G 1/017; G06K 2209/23; H04W 4/44; G06K 9/00785; H04W 4/024

(57) ABSTRACT

A parking guide system may include an entrance sensor, a parking checking sensor configured to identify whether a parking space of the parking lot is occupied by a vehicle, a vehicle detection sensor configured to detect a vehicle, and a controller configured to identify unoccupied parking spaces in the parking lot through the parking checking sensor, to allocate the vehicle recognized by the entrance sensor to one of the unoccupied parking spaces, to identify a location of the vehicle detected by the vehicle detection sensor, and to guide the corresponding vehicle to the parking space through the parking guide unit.

### CROSS REFERENCE TO RELATED APPLICATION

The present application claims priority to Korean Patent Application No. 10-2020-0073827, filed Jun. 17, 2020, the entire contents of which is incorporated herein for all purposes by this reference.

### BACKGROUND OF THE INVENTION

### Field of the Invention

The present invention relates to a parking guide system capable of effectively managing and guiding parking in a parking lot to shorten a parking time and an exiting time (or parking-out time) and allow a user to conveniently use the parking lot, and a method of controlling the same.

### Description of Related Art

As vehicles are prevalent, parking lots are provided for joint use in a downtown area. However, if such a parking lot has a large area, it may take much time to find an empty spot and become congested.

Generally, in the case of such a large parking lot, parking is guided using separate manpower, but an automated system for guiding parking has been adopted due to an increase in labor costs.

However, even the automated system merely informs drivers simply about an empty parking space and users experience inconvenience due to errors thereof

Meanwhile, in line with an introduction of autonomous vehicles, autonomous parking, that is, an auto valet function, may be utilized through communication between a vehicle and a system, and in such an environment, a new system different from the existing system may be required.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a parking guide system configured for effectively managing and guiding parking in a parking lot to shorten a parking time and an exiting time (or parking-out time) and allow a user to conveniently use the parking lot, and a method of controlling the same.

According to various exemplary embodiments of the present invention, a parking guide system includes: an entrance sensor provided at an entrance of a parking lot and configured to recognize a vehicle entering the entrance; a parking checking sensor configured to identify whether each parking space of the parking lot is occupied by a vehicle; a vehicle detection sensor provided in the parking lot and configured to detect a vehicle that drives in the parking lot; and a controller configured to identify unoccupied parking spaces in the parking lot through the parking checking sensor, to allocate the vehicle recognized by the entrance sensor to one of the unoccupied parking spaces, to identify a location of the vehicle detected by the vehicle detection sensor, and to guide the corresponding vehicle to the parking space.

The entrance sensor may recognize the vehicle entering the entrance through communication with the vehicle entering the entrance or a driver terminal of the vehicle entering the entrance through WAVE communication, wireless Internet, or RFID communication therebetween.

The entrance sensor may recognize the vehicle entering the entrance through a camera.

The entrance sensor may recognize a vehicle number of the entering vehicle and provide the recognized vehicle number to the controller.

The vehicle detection sensor may detect the vehicle that drives in the parking lot and deliver detected information to the controller, and the controller may identify whether the detected vehicle is a vehicle for parking or vehicle for exiting (leaving).

The parking guide system may further include: a parking guide unit configured to guide the vehicle that drives in the parking lot to an allocated parking space, wherein the controller may deliver information on the parking space allocated to the corresponding vehicle to the parking guide unit if the detected vehicle is a vehicle for parking in the parking lot.

The parking guide system may further include: a parking guide unit configured to guide the vehicle that drives in the parking lot to an allocated parking space, wherein the controller may guide the vehicle to the parking space through the parking guide unit.

The controller may guide the parking space through the parking guide unit present in an anticipated driving route of the vehicle detected by the vehicle detection sensor.

The anticipated driving route of the vehicle may be a route for the vehicle detected by the vehicle detection sensor to reach the allocated parking space from a detected location of the vehicle detected by the vehicle detection sensor.

The controller may guide the parking space through a first parking guide unit present in the anticipated driving route of the vehicle detected by the vehicle detection sensor.

The parking guide unit may be a vehicle terminal or a driver terminal.

The parking guide unit may guide the allocated parking space and a driving route for the vehicle detected by the vehicle detection sensor to reach the allocated parking space.

The controller may detect an exiting vehicle through the parking checking sensor or the vehicle detection sensor and guide the vehicle exiting the parking lot to an exit of the parking lot through the parking guide unit.

When information on the exit allocated to the parked vehicle is received, the controller may guide the exit allocated to the vehicle through the parking guide unit.

The controller may allocate the vehicle recognized through the entrance sensor to one of the unoccupied parking spaces according to a predetermined priority criterion.

According to various exemplary embodiments of the present invention, a method of controlling a parking guide system includes: identifying whether each parking space of a parking lot is occupied by a vehicle through a parking checking sensor; recognizing a vehicle that enters an entrance of the parking lot through an entrance sensor; identifying unoccupied parking spaces through the parking checking sensor and allocating the vehicle recognized through the entrance sensor to one of the unoccupied parking spaces; and identifying a location of the vehicle detected by a vehicle detection sensor and guiding the corresponding vehicle to the parking space.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1, FIG. 2, FIG. 3, FIG. 4, FIG. 5 and FIG. 6 are views illustrating an operation of a parking guide system according to various exemplary embodiments of the present invention.

FIG. 7 and FIG. 8 are flowcharts of a method of controlling a parking guide system according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

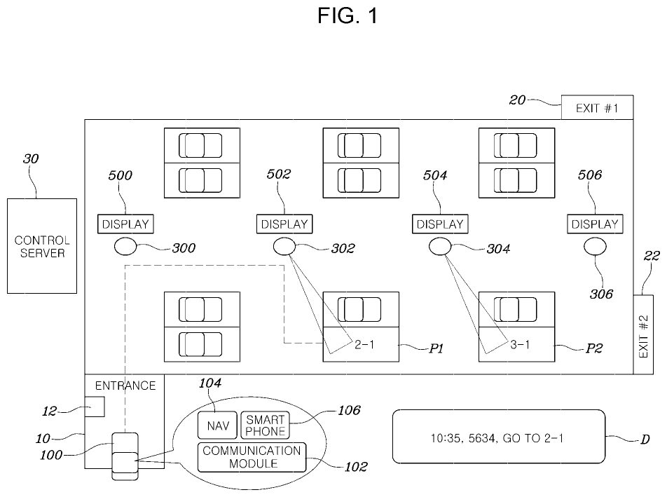

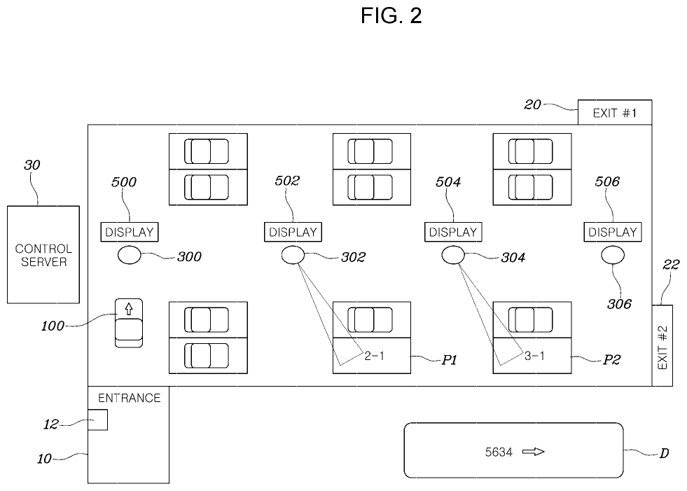

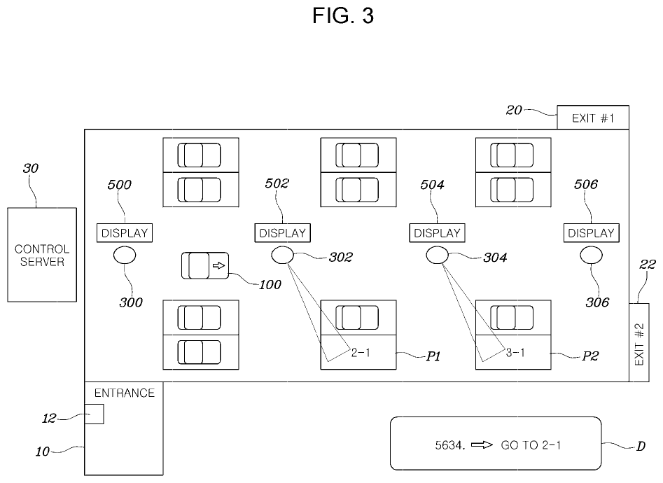

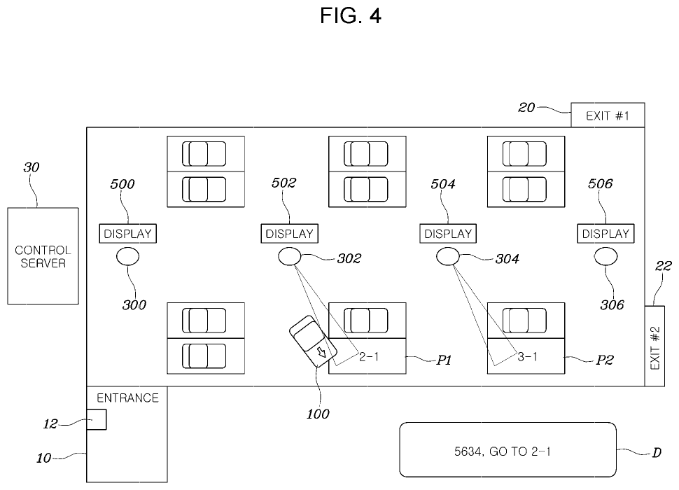

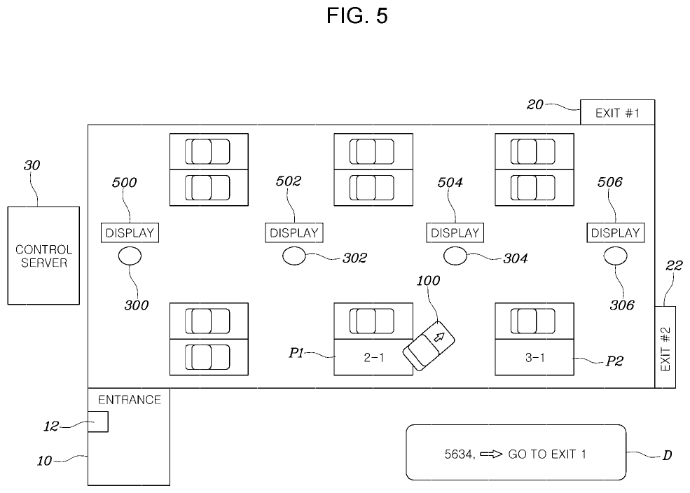

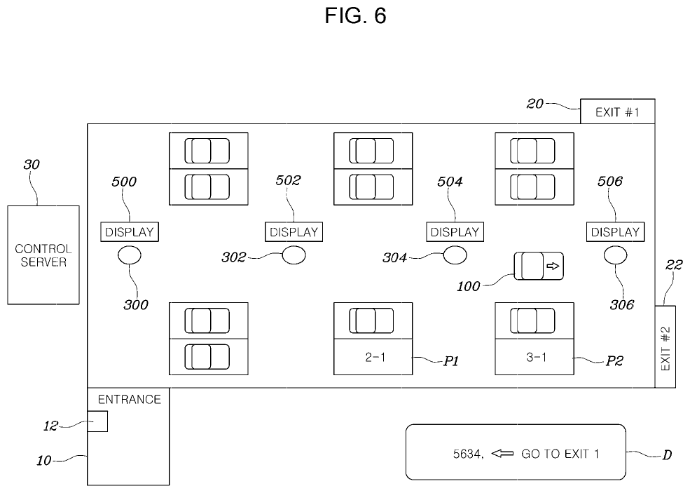

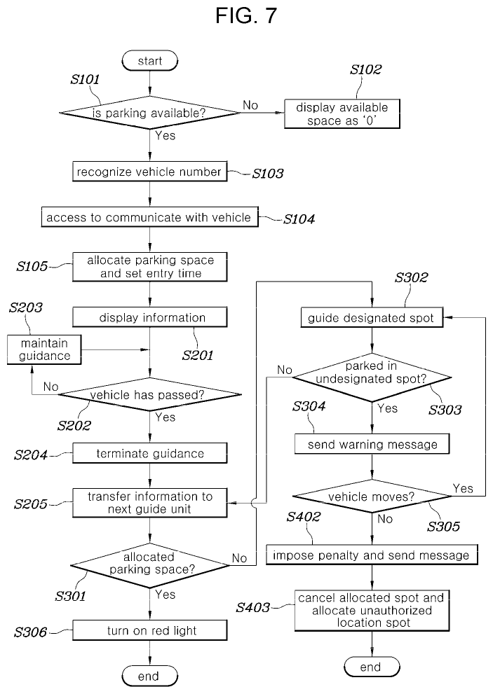

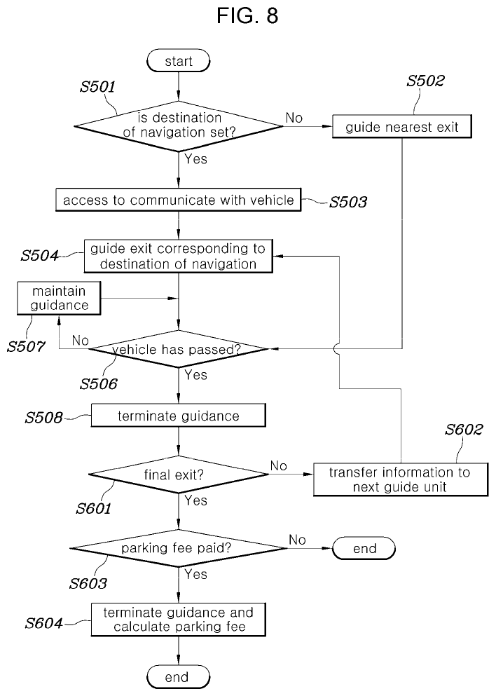

FIG. 1, FIG. 2, FIG. 3, FIG. 4, FIG. 5 and FIG. 6 are views illustrating an operation of a parking guide system according to various exemplary embodiments of the present invention, and FIG. 7 and FIG. 8 are flowcharts of a method of controlling a parking guide system according to various exemplary embodiments of the present invention.

FIG. 1, FIG. 2, FIG. 3, FIG. 4, FIG. 5 and FIG. 6 are views illustrating an operation of a parking guide system according to various exemplary embodiments of the present invention. A parking guide system according to various exemplary embodiments of the present invention includes an entrance sensor 12 provided at an entrance of a parking lot and configured to recognize a vehicle entering the entrance; a parking checking sensor 300 configured to identify whether each parking space of the parking lot is occupied by a vehicle, a vehicle detection sensor 300 provided in the parking lot and configured to detect a vehicle that drives in the parking lot; and a controller 30 configured to identify unoccupied parking spaces in the parking lot through the parking checking sensor 300, to allocate the vehicle recognized by the entrance sensor 12 to one of the unoccupied parking spaces, to identify a location of the vehicle detected by the vehicle detection sensor 300, and to guide the corresponding vehicle to the parking space. In various exemplary embodiments of the present invention, a case where the parking checking sensor and the vehicle detection sensor perform two functions as the same hardware is provided as an example.

The entrance sensor 12 is provided at the entrance of the parking lot of the present invention. The entrance sensor 12 may perform two functions, and recognizes a vehicle that enters first. A vehicle may be recognized using various communication units and a type and number of a vehicle that enters may be recognized using a camera.

When the recognition of the vehicle is completed, whether parking is available and a parking available spot may be guided at the entrance. Furthermore, a user may reserve parking through a terminal such as a smartphone in advance, and in the instant case, the vehicle may be authenticated through the entrance sensor 12 and only the authorized vehicle may be allowed to enter at the entrance of the parking lot.

Meanwhile, after the vehicle enters, a parking location may be guided through a map of the parking lot by activating a navigation 104. At the time of entering, the controller 30 may allocate an available parking space P1 to the corresponding vehicle and set a driving route from the entrance to the parking space P1.

Furthermore, the controller 30 may also allocate the vehicle recognized through the entrance sensor to one of the unoccupied parking spaces according to a predetermined priority criterion. For example, in the case of an apartment or building, a vehicle of a resident living in the corresponding apartment or building may be preferentially allocated a parking space close to an entrance of the corresponding living space.

The parking lot is provided with a plurality of parking checking sensors 300, 302, 304, and 306 to determine whether each of parking spaces P1 and P2 is occupied by a vehicle. Various means such as near-infrared rays, radio frequency identification (RFID), a camera, and the like may be used to check parking and may be provided at each check parking spaces near intersections provided at each junction of the parking lot to check a nearby parking space.

Furthermore, a plurality of vehicle detection sensors 300, 302, 304, and 306 for detecting a vehicle driving in the parking lot is provided in the parking lot. The vehicle detection sensor 300 may also be used in various ways. Typically, the vehicle detection sensor 300 may detect a movement direction and a location of a vehicle whose number is recognized through a camera. The vehicle detection sensor 300, which is the same sensor as the parking checking sensor 300, may be a sensor that realizes multi-function.

Meanwhile, a plurality of parking guide units 500, 502, 504, and 506 for guiding a vehicle driving in the parking lot to a parking space allocated to the vehicle. The parking guide unit 500, which is configured to guide the recognized vehicle to the parking space, may be provided in a form of a display at each joint in the parking lot. Furthermore, the parking guide unit is not limited to only the hardware of the parking lot and may perform its role through various terminals such as the navigation 104 of the vehicle or the user's smartphone 106. In the instant case, the terminal of the vehicle or the user may need a communication module 102 configured for exchanging information through communication with the server of the parking lot, i.e., the controller.

The controller 30 which is configured as a server identifies parking spaces P1 and P2 that are not occupied through the parking checking sensor 300, allocates a vehicle recognized through the entrance sensor 12 to one parking space P1 among the unoccupied parking spaces, identifies a location of the vehicle detected by the vehicle detection sensor 300, and guides the corresponding vehicle to the parking space P1 through the parking guide unit 500.

Through such a configuration, specific parking guidance may be provided to each individual vehicle that enters the parking lot, and even a driving route may be guided in the parking lot at the time of guiding parking, whereby congestion in the parking lot may be reduced, parking fees may be collected, and the space may be efficiently utilized.

The entrance sensor 12 may recognize an entering vehicle by communicating with the entering vehicle or a terminal of a driver of the vehicle through WAVE communication, wireless Internet, or RFID communication therebetween. Also, the entrance sensor 12 may recognize the vehicle entering the entrance through the camera. Furthermore, the entrance sensor may recognize a vehicle number of the entering vehicle and provide the recognized vehicle number to the controller 30.

Meanwhile, when the vehicle detection sensor 300 detects the vehicle driving in the parking lot, the vehicle detection sensor 300 may deliver the detected information to the controller 30, and the controller 30 may identify whether the detected vehicle is a vehicle to park or a vehicle to exit (leave) through the detected information. If the detected vehicle is a vehicle to park, the controller 30 may deliver information on a parking space allocated to the corresponding vehicle to the parking guide unit 500.

Furthermore, the controller 30 may guide the vehicle to the parking space through the parking guide unit 500 present in an anticipated driving route of the vehicle detected by the vehicle detection sensor 300. Alternatively, in the case of an autonomous vehicle, it is possible to guide or control the vehicle to an allocated parking space.

The anticipated driving route of the vehicle may be a route from the detected location of the vehicle detected by the vehicle detection sensor 300 to reach the allocated parking space. Furthermore, the controller 30 may sequentially guide the parking spaces, starting from the first parking guide unit 500 existing in the anticipated driving route of the vehicle detected by the vehicle detection sensor 300. The parking guide unit 500 may be a vehicle terminal or a driver's terminal. Furthermore, the parking guide unit 500 may guide the allocated parking space and the driving route for reaching the allocated parking space.

Meanwhile, the controller 30 may detect a vehicle that exits through the parking checking sensor 300 or the vehicle detection sensor 300, and guide the vehicle to an exit through the parking guide unit 500. If information on an exit allocated to a parked vehicle is provided, the controller 30 may guide the vehicle to an exit 20 or 22 allocated to the vehicle through the parking guide unit 500. Also, in the case of an autonomous vehicle, the controller may directly control the vehicle to drive toward the parking space, or provide a route to the vehicle.

FIG. 1, FIG. 2, FIG. 3, FIG. 4, FIG. 5 and FIG. 6 are views illustrating an operation of a parking guide system according to various exemplary embodiments of the present invention. First, when a vehicle 100 enters the entrance 10, the vehicle is recognized and recorded through the entrance sensor 12. The parking space P1 is allocated to the vehicle. Also, information indicating that the vehicle (5634 vehicle) has entered at 10:35 and may park in a zone 2-1 is output through the terminals 104 and 106 of the vehicle or the user or through the parking guide unit display 500 in the parking lot (D). As for the allocation of the parking space, a nearest space or a least congested spot is allocated as the parking space and provided.

When the vehicle 100 enters the parking lot as shown in FIG. 2, the vehicle is recognized through the vehicle detection sensor 300 and a driving direction (right turn) is guided through the display D of the parking guide unit 500.

Also, the vehicle 100 is continuously recognized and the driving direction (right turn) is guided as shown in FIG. 3.

Thereafter, when the vehicle 100 approaches a spot of the parking space P1 as shown in FIG. 4, information on the specific parking space 2-1 is provided so that the vehicle 100 may be parked at a predetermined location.

FIG. 5 shows a process of exiting. When the vehicle 100 exits, the exit 20 in a direction in which a destination designated in the navigation may reach at the earliest may be guided, or otherwise the nearest exit or a less congested exit may be guided. In the instant case, the #1 exit 20 is guided.

As shown in FIG. 6, the vehicle 100 that exits is recognized, and the exit 20 is guided so that the vehicle may smoothly exit.

FIG. 7 and FIG. 8 are flowcharts of a method of controlling a parking guide system according to various exemplary embodiments of the present invention. The method of controlling a parking guide system includes identifying whether each parking space of a parking lot is occupied by a vehicle through a parking checking sensor (S101), recognizing a vehicle that enters an entrance of the parking lot through an entrance sensor (S103), identifying unoccupied parking spaces through the parking checking sensor and allocating the vehicle recognized through the entrance sensor to one of the unoccupied parking spaces (S105), and identifying a location of the vehicle detected by a vehicle detection sensor and guiding the corresponding vehicle to the parking space (S203).

The case of FIG. 7 shows a process of parking.

When a vehicle arrives at the entrance, it is determined whether a current parking space of the parking lot is at an acceptable level (S101 and S102). If the parking space is at the acceptable level, a number of the vehicle is recognized (S103). Accordingly, communicate with the vehicle is attempted (S104), a parking space is allocated, and an entry time is set and recorded (S105).

When the allocation of the parking space is completed, information on the parking space is displayed through the vehicle or the terminal (S201), and when the vehicle passes through the entrance, guidance at the entrance is terminated (S202, S203, and S204). The information related to the vehicle is guided through a next parking guide unit (S205).

When the vehicle reaches the allocated parking space, the guidance is terminated (S301), or otherwise the guidance is continuously provided through the parking guide unit (S306 and S302). If the vehicle is parked in an undesignated space, a warning is issued using a speaker or lighting of the parking lot (S303 and S304). If the vehicle does not move in spite of the warning, a penalty is imposed and a message is sent to the user's terminal or the like (S306 and S402). Also, the allocated parking space is canceled so that another vehicle may be parked, and it is recorded that the corresponding parking space has been parked and the corresponding violation vehicle is charged with the penalty when exiting (S403).

FIG. 8 is a flowchart illustrating a process of exiting. First, when a driver inputs a destination through a navigation of the vehicle or a terminal, the destination information is delivered to the controller and the controller selects and guides an exit nearest to the destination (S501, S503, and S504). If a destination is not set, an exit nearest to a parked location is guided (S502). Whether the vehicle is to exit may be received through the user's terminal or may be recognized through movement of the parked vehicle through the vehicle detection sensor.

The controller communicates with the vehicle and monitors whether the vehicle properly passes through a guided point (S506, S507, and S508). When the vehicle reaches the exit, the controller is configured to determine a parking fee (S601, S603, and S604). If the vehicle does not reach the exit yet, the controller continues to guide the exit through the parking guide unit present on a driving route of the vehicle (S602).

According to the parking guide system and the control method of the present invention, by effectively performing parking management and guidance of the parking lot, a parking time and an exiting time may be shortened and the user may conveniently use the parking lot.

In various exemplary embodiments of the present invention, each operation described above may be performed by a controller, and the controller may be configured by a plurality of controllers, or an integrated single controller.

Furthermore, the term “controller”, “control unit” or “control device” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller or the control unit may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A parking guide system comprising:
an entrance sensor provided at an entrance of a parking lot and configured to recognize a vehicle entering the entrance;
a parking checking sensor configured to identify whether each parking space of the parking lot is occupied by a vehicle;
a vehicle detection sensor provided in the parking lot and configured to detect a vehicle that drives in the parking lot; and
a controller configured to identify unoccupied parking spaces in the parking lot through the parking checking sensor, to allocate a parking space among the unoccupied parking spaces to the vehicle recognized by the entrance sensor, to recognize a location of the vehicle detected by the vehicle detection sensor, and to guide the vehicle detected by the vehicle detection sensor to one of the unoccupied parking spaces.

2. The parking guide system of claim 1, wherein the entrance sensor is configured to recognize the vehicle entering the entrance through communication with the vehicle entering the entrance or a driver terminal of the vehicle entering the entrance through WAVE communication, wireless Internet, or RFID communication therebetween.

3. The parking guide system of claim 1, wherein the entrance sensor is configured to recognize the vehicle entering the entrance through a camera.

4. The parking guide system of claim 1, wherein the entrance sensor is configured to recognize a vehicle number of the vehicle entering the entrance and to provide the recognized vehicle number to the controller.

5. The parking guide system of claim 1, wherein the vehicle detection sensor is configured to detect the vehicle that drives in the parking lot and to deliver detected information related to the vehicle that drives in the parking lot, to the controller, and the controller is configured to identify whether the detected vehicle is a vehicle for parking in the parking lot or a vehicle for exiting the parking lot.

6. The parking guide system of claim 5, further including:
a parking guide unit configured to guide the vehicle that drives in the parking lot to the allocated parking space,
wherein the controller is configured to deliver information on the parking space which is allocated to the vehicle that drives in the parking lot to the parking guide unit when the detected vehicle is the vehicle for parking in the parking lot.

7. The parking guide system of claim 1, further including:
a parking guide unit configured to guide the vehicle that drives in the parking lot to the allocated parking space,
wherein the controller is configured to guide the vehicle that drives in the parking lot to the allocated parking space through the parking guide unit.

8. The parking guide system of claim 7, wherein the controller is configured to guide the vehicle that drives in the parking lot to the allocated parking space through the parking guide unit present in an anticipated driving route of the vehicle detected by the vehicle detection sensor.

9. The parking guide system of claim 8, wherein the anticipated driving route of the vehicle detected by the vehicle detection sensor is a route for the vehicle detected by the vehicle detection sensor to reach the allocated parking space from the location of the vehicle detected by the vehicle detection sensor.

10. The parking guide system of claim 9, wherein the controller is configured to guide the vehicle detected by the vehicle detection sensor to the allocated parking space through a first parking guide unit present in the anticipated driving route of the vehicle detected by the vehicle detection sensor.

11. The parking guide system of claim 7, wherein the parking guide unit is a vehicle terminal or a driver terminal.

12. The parking guide system of claim 7, wherein the parking guide unit is configured to guide the allocated parking space and a driving route for the vehicle detected by the vehicle detection sensor to reach the allocated parking space.

13. The parking guide system of claim 7, wherein the controller is configured to detect a vehicle exiting the parking lot through the parking checking sensor or the vehicle detection sensor and to guide the vehicle exiting the parking lot to an exit of the parking lot through the parking guide unit.

14. The parking guide system of claim 13, wherein the controller is configured to guide the vehicle exiting the parking lot to the exit through the parking guide unit when information on the exit allocated to the parked vehicle is received by the controller.

15. The parking guide system of claim 1, wherein the controller is configured to allocate a parking space among the unoccupied parking spaces to the vehicle recognized through the entrance sensor according to a predetermined priority criterion.

16. A method of controlling the parking guide system of claim 1, the method including:
identifying, by the controller, whether each parking space of the parking lot is occupied by a vehicle through the parking checking sensor;
recognizing, by the controller, the vehicle that enters the entrance of the parking lot through the entrance sensor;
identifying, by the controller, the unoccupied parking spaces through the parking checking sensor and allocating the parking space among the unoccupied parking spaces to the vehicle recognized through the entrance sensor; and
identifying, by the controller, a location of the vehicle detected by the vehicle detection sensor and guiding the vehicle detected by the vehicle detection sensor to the allocated parking space.

17. The method of claim 16, wherein the controller includes:
a processor; and
a non-transitory storage medium on which a program for performing the method of claim 16 is recorded and executed by the processor.

18. The method of claim 16, wherein the controller is configured to guide the vehicle that drives in the parking lot to the allocated parking space through a parking guide unit present in an anticipated driving route of the vehicle detected by the vehicle detection sensor.

19. The method of claim 16, wherein the controller is configured to detect a vehicle exiting the parking lot through the parking checking sensor or the vehicle detection sensor and to guide the vehicle exiting the parking lot to an exit of the parking lot through a parking guide unit.
